(19) United States
(12) Patent Application Publication
(10) Pub. No.: US 2011/0248505 A1
(43) Pub. Date: Oct. 13, 2011

(54) Energy Generating Unit and Method for Maintaining an Energy Generating Unit

(75) Inventors: Peer SRINGER, Neuhofen (DE); Thomas Pensler, Langenbogen (DE); Ulrich Traugott, Frankenthal (DE); Josephine Vega-Voelk, Lampertheim (DE); Lenard Vorpahl, Kaiserslautern (DE)

(73) Assignee: KSB Aktiengesellschaft, Frankenthal (DE)

(21) Appl. No.: 13/099,904

(22) Filed: May 3, 2011

Related U.S. Application Data
(63) Continuation of application No. PCT/EP2009/007737, filed on Oct. 29, 2009.

(30) Foreign Application Priority Data
Nov. 3, 2008 (DE) 10 2008 054 361.6

(51) Int. Cl. F03B 13/10; B23P 6/00

(52) U.S. Cl. 290/54; 29/402.03

(57) ABSTRACT

An energy generating unit especially for installation on a bed of a stream of water or floating in the water, composed of a plurality of components, such as an inlet housing, a turbine housing, a drive unit arranged in the turbine housing, and a downstream draft tube, in which at least one component is provided with remotely operable connectors and with guides so as to be separable from at least one other component while in the water such that the at least one component, such as the drive unit, can be removed from the water for maintenance while the at least one other component, such as the draft tube, remains in the water, as well as a method for maintaining such an energy generating unit by selectively removing at least one component from the water while at least one other component remains in the water.

### CROSS REFERENCE TO RELATED APPLICATIONS

This application is a continuation of international patent application no. PCT/EP2009/007737, filed Oct. 29, 2009 designating the United States of America and published in German on 3 Jun. 2010 as WO 2010/060520, the entire disclosure of which is incorporated herein by reference. Priority is claimed based on Federal Republic of Germany patent application no. DE 10 2008 054 361.6, filed Nov. 3, 2008, which likewise is incorporated by reference.

### BACKGROUND OF THE INVENTION

The present invention refers to an energy generating unit, especially an energy generating unit standing on a bed of a stream of water or floating in the water, and also to a method for maintaining an energy generating unit.

Energy generating units, especially river water turbines, which for example are used in a non-navigable region of a river, are already known from the prior art.

A river water turbine of this type is already known from U.S. 2007/096472 (=WO 2005/078276) in which slowly rotating, axially impinged turbine rotor wheels with rigid or movable blades are suspended in a performance-optimized flow housing which is enclosed by a box-like sheet steel jacket which surrounds the sides, top and bottom of the housing and is protected on the inlet side by a steel rotating trash screen.

Also, a river water turbine in which the inlet, turbine and draft tube section are enclosed by a common housing, which has a tubular shape, is known from U.S. Pat. No. 4,868,408.

DE 10 2005 040 807 A1 furthermore discloses a river water turbine exposed to axial throughflow for use in a flowing stream, the turbine housing of which is designed in such a way that the flow energy of the external stream creates an injector action, and therefore a suction, on the outlet of a horizontally arranged draft tube, as a result of which the usable pressure drop in the turbine stage, and therefore the power output of the turbine, can be additionally increased.

The river water turbines described above, however, have the problem that in order to carry out maintenance operations the complete river water turbine basically has to be lifted out as a unit because of the continuous and one-piece outer housing and is then to be repaired on a pontoon or on land. This is understandably exceptionally expensive, especially with regard to time consumption, use of deck cranes or the like, for example, and also with regard to the personnel to be employed. Thus, service operations for such river turbines are exceedingly costly to manage and carry out.

### SUMMARY OF THE INVENTION

It is therefore the object of the present invention to advantageously further develop an energy generating unit of the type referred to in the introduction, especially to the effect that this can be operated more efficiently and can be maintained more easily.

This object is achieved according to the invention by the energy generating unit as described and claimed hereinafter.

Accordingly, an energy generating unit, in particular an energy generating unit standing on a bed of a stream of water and/or floating in the water, is provided which is comprised of components, the components comprising an inlet housing, a turbine housing, a drive unit which is arranged in the turbine housing, and a downstream draft tube, wherein provision is made for at least one releasable connector for connecting the components, which connector is constructed as at least partially remotely operable and/or at least one releasable latch with a guide for bringing adjoining components together and/or moving them apart. In particular, the invention makes it advantageously possible that no provision is to be made for a continuous, one-piece main housing or outer housing of the energy generating unit. Rather, the energy generating unit is constructed in a modular manner, wherein for maintenance, repair or exchange, for example, only the respective component needs to be removed and lifted out of the water. The drive unit in this case can be constructed in such a way that it has a turbine, a generator or a prime mover and/or driven machine and optionally energy transmission means or connections, for this purpose. As a result, the advantage of improved and shortened maintenance arises since in order to maintain the turbine it is no longer necessary to bring the complete energy generating unit to the surface and to totally disassemble and strip down the unit in order to undertake possible maintenance operations, especially routine maintenance operations, on the turbine.

The components of the energy generating unit in this case are preferably chosen with regard to number, position, orientation and size in such a way that the forces and moments encountered during operation are optimally absorbed. In this case, the respective boundary conditions with regard to the site of the energy generating unit are advantageously taken into consideration. The modular construction results in the operating costs being lowered and the construction being simplified overall. Because of the simpler maintenance possibilities, new design possibilities for the components arise, since plans can be made with other values with regard to stability and with regard to maintenance intervals. The production and development costs are therefore reduced.

It is possible to design the connectors at least partially as remotely operable and/or releasable latches. As a result, the advantage arises of lowering the energy generating unit into its operating position and arranging it there in a secure but re-releasable manner. As a result of the possibility of remote operation, it is not necessary to employ divers, for example, since components to be maintained, for example, can be unlocked and released due to their remotely operable nature. Removal from the water is then possible in a simple manner, for example from a boat. In this context the term “remotely operable latches” is understood to include remotely controllable latching or unlatching actuators, for example, but also latches which can be reached and released, for example, via opening rods. As a result of the provided guides, by which adjoining components can be brought together and/or moved apart, the removal and assembly are additionally simplified.

It is also possible to construct the connectors at least partially as hook-in and/or lift connections. In addition, such a development allows any defective components, for example, to be quickly exchanged.

Furthermore, one or more hinged joints can be provided for pivoting of one or more parts of the energy generating unit and/or for mutually pivoting components relative to each other. Such pivotability has the advantage of pivoting the inlet housing in relation to the turbine housing, for example, in order to subsequently remove parts of the drive unit, such as the turbine of the energy generating unit, for maintenance purposes. For this purpose, guide rails can be provided inside the turbine housing for guide rails for guiding the turbine in and/ or out of the housing in a simple manner.

The energy generating unit can be constructed in such a way that at least one door and/or flap is provided on the energy generating unit by which the drive unit, or parts of the drive unit, can be removed. It this regard, it is advantageous if such a door or flap is attached on the upper side of the energy generating unit. This arrangement has the advantage that the drive unit, or parts of the drive unit, is or are readily accessible from a boat or ship and can be conveniently removed and maintained or, if necessary, exchanged.

It is furthermore possible to provide anchors for anchoring at least some of the components on the bed of the stream of water. It is advantageous in this case if particularly those components which according to experience have longer maintenance intervals than the other components, have respective anchors. As a result, the advantage arises that components needing maintenance can be readily removed from the energy generating unit, whereas other components which do not yet require maintenance can remain in the river. This particularly applies to the draft tube, for example, since this represents a component which is relatively large but as such is almost maintenance-free. In this connection, it can be expedient if the anchoring is not carried out directly on the bed of the stream of water but at a certain safety distance above it. As a result of this, the entry of harmful elements into the turbine can be avoided.

It is advantageous if the anchors comprise an extractable and/or detachable suspension device, or are designed as such. Therefore, provision can be made on the bed of the stream of water, for example, for anchored hook elements to which the energy generating unit and/or components of the energy generating unit can be hooked or on which they can be suspended.

Furthermore, the anchors may comprise self-positioning and/or self-locking suspension elements and/or connectors, or be designed as such. Such suspension elements and/or connectors may, for example, comprise wedging elements, snap-in hooks or catches. Use of self-positioning and self-locking anchors has the advantage that a secure anchoring can be ensured.

Furthermore, it is preferred if buoyancy elements or tanks are provided attached to and/or associated with at least some of the components. This is particularly advantageous when components like the draft tube are to remain on the river bed, for example, during the maintenance of other components. The buoyancy tanks have the effect of these other components not sinking to the bottom but remaining just beneath the surface of the water due to the buoyancy. The buoyancy tanks may be constructed at least partially as tanks which can be filled with water or compressed air as necessary, for example, to adjust the buoyancy level. In this regard, it is conceivable that the energy generating unit has a separate or a central control system and/or regulating system which inter alia also controls or regulates the buoyancy level or flotation height, specifically by filling the tanks with compressed air or water.

Furthermore, it is possible to construct the draft tube with buoyancy tanks or floats so that it has an independently floatable construction, or to anchor the draft tube independently on the bed of the stream of water. In this case, the draft tube may be provided with a a segmented wall structure, for example, in which buoyancy tanks or floats are accommodated. In addition, it is possible in this case for the draft tube to be independently anchored, for example by an anchor chain, directly to the bed of the stream of water. This has the advantage that the draft tube can be completely disconnected from the remaining parts of the energy generating unit and left at site without further measures having to be taken.

Furthermore, a device for trapping debris, for example a trash screen, may be arranged in front of the inlet housing. Such a trash screen has the advantage that flotsam, for example, can be prevented from entering the turbine and in this way damage to the turbine can be avoided.

In addition, it is preferred if the draft tube is constructed as an oval or elliptical diffuser. As a result, the overall height is reduced in comparison to a device with a hydromechanically optimum circular outlet with the same outlet area, and it is possible to use the generating unit in streams with low water levels. In addition, as a result of this design the positional stability of the energy generating unit is increased. This shape of the diffuser can be realized in a simple and inexpensive manner, for example, by constructing the non-curved walls from steel plate, while the curved walls are produced from GFK tube. The plates and tubes can be fastened together with screws or bolts in this case, and the upper and lower plates optionally can be stabilized by struts.

Furthermore, pick-up points and/or attachments may be provided on at least some of the components for lifting the components out of the water. Such pick-up points may be pins, hooks or welded-on perforated plates, for example, on which lifting means such as cables can be attached. This makes it easier to lift the respective component with a deck crane jib, for example.

Furthermore, the invention also relates to a method for maintaining an energy generating unit of the invention. Accordingly, it is provided that for maintaining an energy generating unit—especially an energy generating unit standing on a bed of a stream of water or floating in the water comprised of components comprising an inlet housing, a turbine housing, a drive unit which is arranged in the turbine housing, and a downstream draft tube—the draft tube remains in the water during maintenance of the energy generating unit while at least one other component of the energy generating unit to be maintained is removed from the water for maintenance. The component to be maintained is preferably the drive unit or parts of the drive unit, such as the turbine. The term maintenance in this context is to be understood as a generic term for repair, visual inspection, exchange or similarly supported activities related to the operation of the energy generating unit.

Furthermore, unit can be constructed so that the drive unit can be removed for maintenance while the remaining components remain in the water.

It is preferred if the energy generating unit is an energy generating unit comprised of components connectable by releasable connectors in the form of remotely operable latches with guides for bringing the components together.

### BRIEF DESCRIPTION OF THE DRAWINGS

The invention will be described hereinafter in further detail with reference to illustrative preferred embodiments shown in the accompanying drawing figures, in which:

FIG. 1 is a perspective view of an energy generating unit constructed according to the present invention;

FIG. 2 is an exploded perspective view of the energy generating unit of FIG. 1;

FIG. 3 is a plan view of the energy generating unit of the invention;

FIG. 4 is a side view of the energy generating unit according to the invention;

FIG. 5 is a detailed perspective view of the turbine housing with the rotor;

FIG. 6 is a perspective view of the diffuser, and

FIG. 7 is a perspective view of a further embodiment of the energy generating unit of the invention.

### DETAILED DESCRIPTION OF PREFERRED EMBODIMENTS

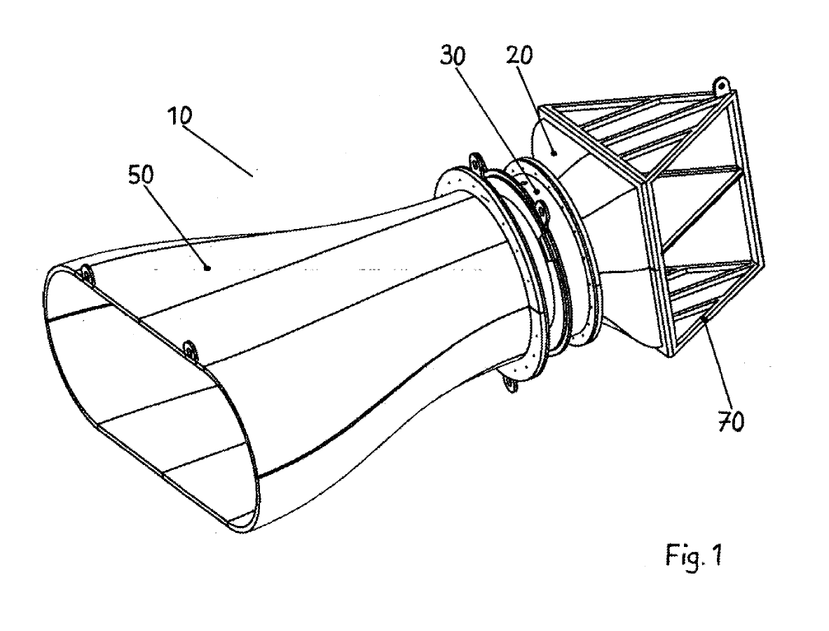

FIG. 1 shows an energy generating unit 10 which can be arranged in a manner both standing on a bed of a stream of water and floating in the water. Such an energy generating unit 10 is preferably arranged in the flow regions of a stream of water, especially a river, which is non-navigable. In this case, it is conceivable, for example, to equip the energy generating unit 10 with signaling means like a buoy in order to mark the shipping channel.

The modularly constructed energy generating unit in this case comprises a plurality of components 20, 30, 40, 50, which in their turn are releasably connected by connectors. In detail, the components 20, 30, 40, 50 in this case are the inlet housing 20, the turbine housing 30, the downstream draft tube 50 which in the embodiment shown here is constructed as a diffuser 50, and also a trapping device 70 in front of the inlet housing 20 for preventing the entry of foreign objects into the energy generating unit 10.

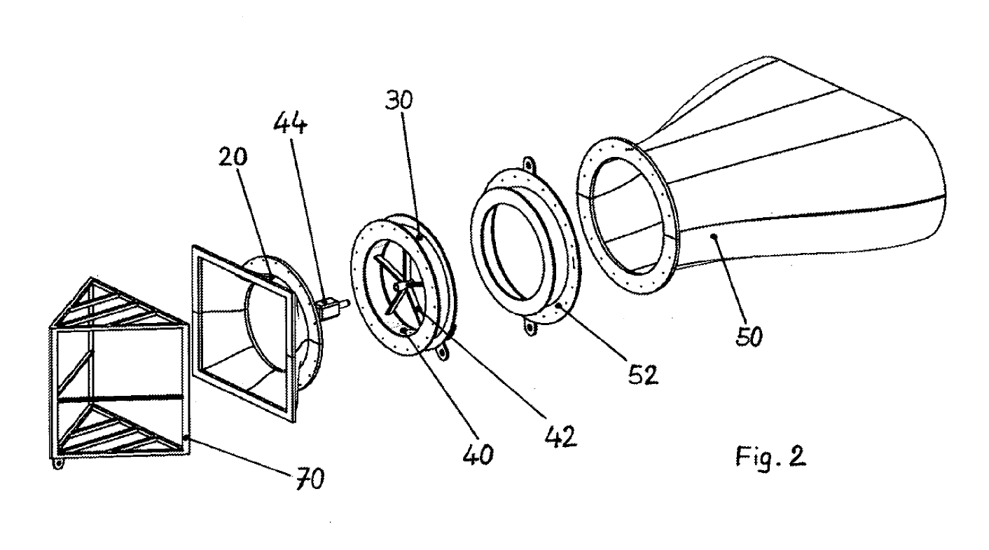

FIG. 2 shows an exploded view of the energy generating unit which is shown in FIG. 1. In addition to the components which are already described in FIG. 1, in FIG. 2 the drive unit 40, which comprises the turbine 42 and a generator 44, is shown. The drive unit 40 in this case is accommodated in the turbine housing 30 which is located between the inlet housing and the component parts of the diffuser 50. Located in front of the diffuser 50 in this case is an additional component, specifically an extension ring 52 which directly adjoins the turbine housing 30 and guides the directed water flow into the diffuser 50.

In order to maintain the energy generating unit 10, for example to exchange the generator, the trapping device 70 and inlet housing 20 can be removed. For this purpose, provision is made for connectors, such as screw connections or hook-in- and/or lifting connections, which are simple to release. Alternatively, provision may be made for hinged joints between inlet housing 20 and turbine housing 30 so that only a lock is to be released and inlet housing 20 together with the trapping device 70 are to be folded away in order to reach the drive unit 40.

These method steps can be readily carried out from a pontoon, a ship or by divers. As a rule, however, a heavy crane is not needed. The remaining components, that is to say the turbine housing 30, the extension ring 52, the draft tube 50 and, in the case of the jointed construction, also the inlet housing 20 with the trapping device 70, remain in the water and do not have to be brought to the surface or raised if, for example, only the generator 44 is to be changed, repaired or inspected.

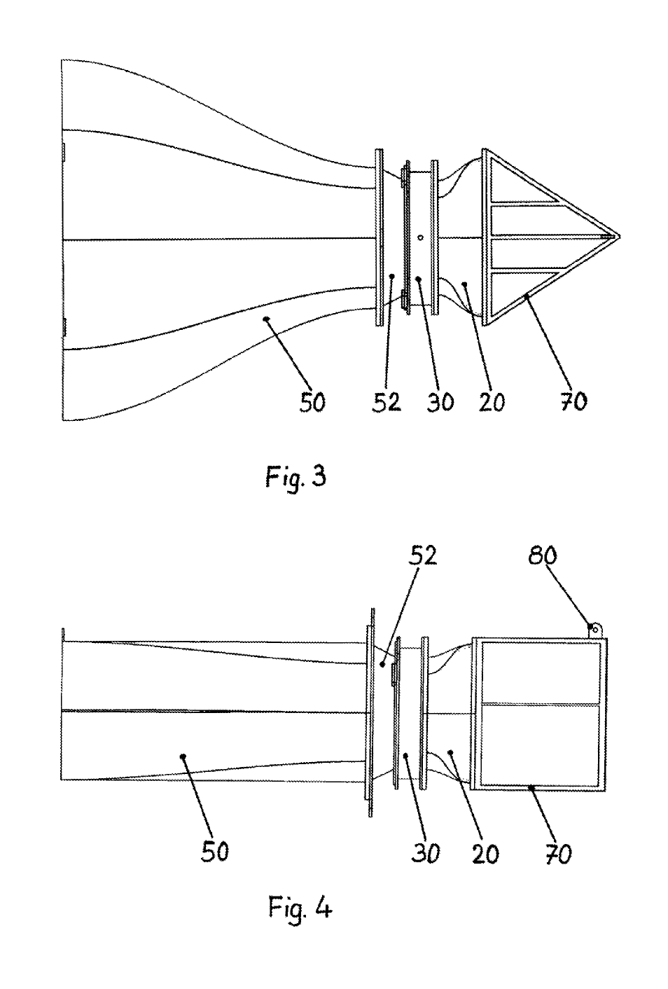

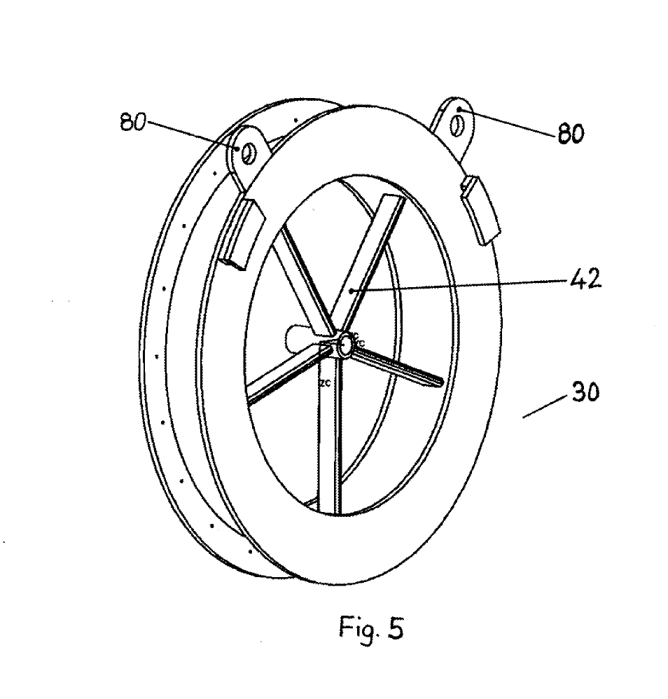

FIGS. 3 and 4 show the energy generating unit 10 again in plan view and side view. As easily seen from FIG. 4, the energy generating unit 10 essentially has a uniform overall height which allows such an energy generating unit 10 to be used even in shallow waters.

As can be seen from FIG. 3, the diffuser 50, which in the end region has an essentially oval construction in cross section, changes from a round cross-sectional shape of the extension ring 52, widening to the oval cross-sectional shape in the end region. Therefore, as a result of the oval cross-sectional shape at the outlet or end region of the diffuser 50, the same outlet area is maintained in comparison to the hydrodynamically, actually more favorable round cross-sectional shape, but the overall height, for example of the inlet housing 20, is not exceeded. In addition, an improved positional stability accompanies this design since in the case of this construction the diffuser 50 is less inclined to roll in choppy water.

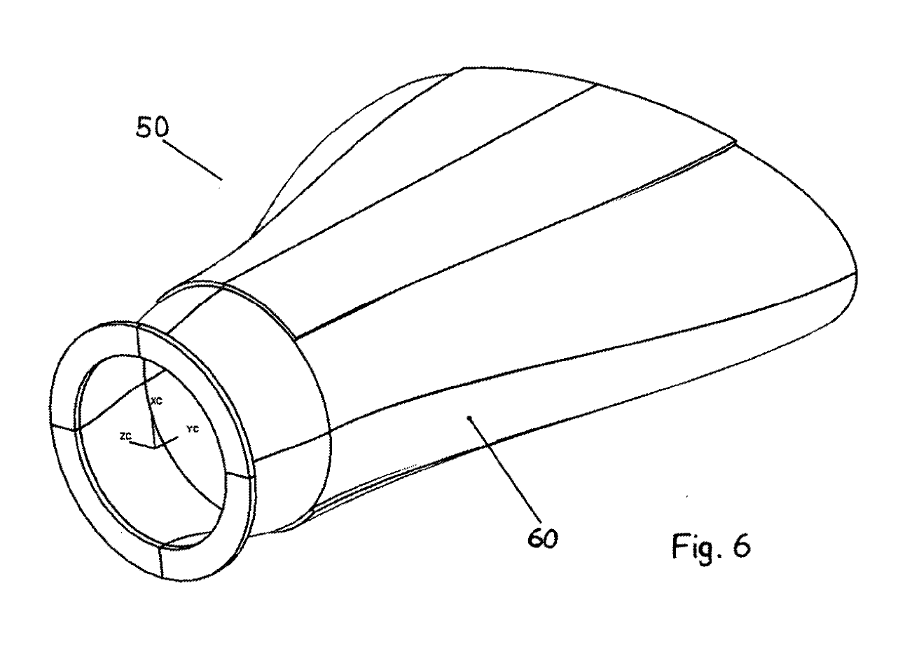

FIG. 5 shows a detail view of the turbine housing 30 in which the turbine 44 is arranged. In this case, the turbine housing 30 has two pick-up points 80 on which lifting means, which are not shown in more detail, can be fastened in order to lift the turbine housing 30 out of the water for maintenance or repair purposes, for example.

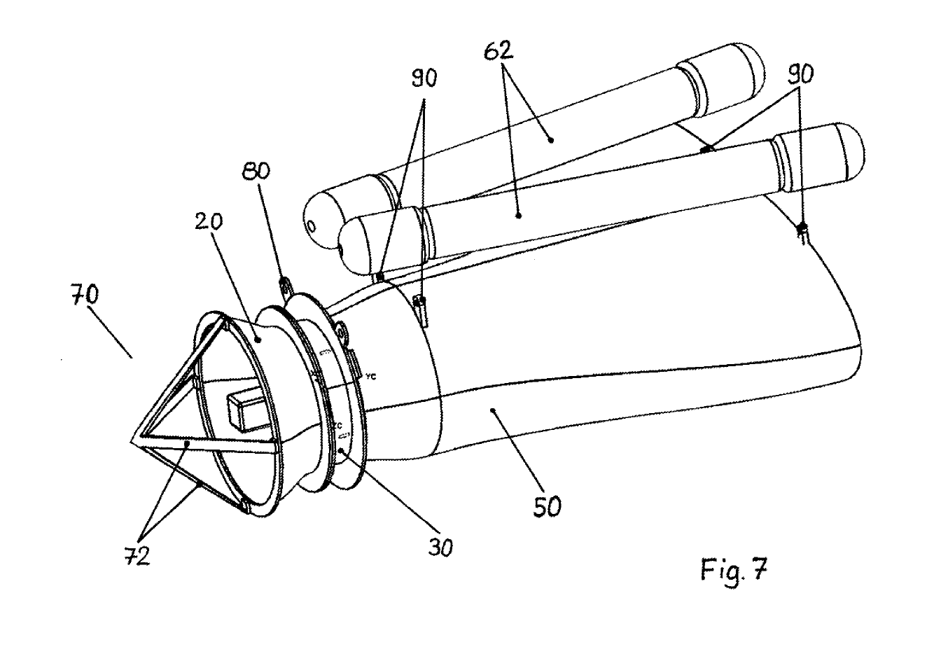

FIG. 6 shows a perspective view of the diffuser 50. In this case, the diffuser 50 on its upper and lower sides, in the less curved regions of the wall, has buoyancy tanks 60 constructed as hollow chambers into which compressed air can be blown, depending upon the required degree of buoyancy. For sinking, it is also possible to flood these buoyancy tanks 60 which are constructed as buoyancy bodies.

A further possible solution with regard to the buoyancy tanks 60 is shown in FIG. 7. In this case, external tanks 62 are arranged on the upper side or lower side of the diffuser 50. For this purpose, perforated plates 90 on which the tanks 62 can be fastened are provided on the upper side of the diffuser.

Furthermore, an alternative embodiment of an upstream trapping device 70 is shown in FIG. 7. This trapping device 70 in this case comprises struts 72 arranged in the shape of a pyramid, which are fastened on the inlet housing 20 and are to prevent entry of foreign bodies such as flotsam. In addition, in contrast to the illustrative embodiment shown in FIGS. 1 to 4, in this embodiment there is no provision for an extension ring 52 between turbine housing 30 and draft tube 50.

The foregoing description and examples have been set forth merely to illustrate the invention and are not intended to be limiting. Since modifications of the described embodiments incorporating the sprit and substance of the invention may occur to persons skilled in the art, the invention should be construed broadly to include all variations within the scope of the appended claims and equivalents thereof.

1. An energy generating unit for installation on a bed of a stream or floating in a stream, said energy generating unit being comprised of components comprising an inlet housing, a turbine housing, a drive unit arranged in the turbine housing, and a downstream draft tube, and said energy unit further comprising:
releasable connectors for connecting the components, said connectors being constructed at least partially as remotely operable or releasable latches, and
guides for bringing together adjoining components or moving them apart.

2. An energy generating unit as claimed in claim 1, wherein the connectors are constructed at least partially as hook-in and/or lifting connections.

3. An energy generating unit as claimed in claim 1, wherein at least one pivotable joint is provided for pivoting of a part of the energy generating unit or for mutual pivoting of components of the energy generating unit.

4. An energy generating unit as claimed in claim 1, wherein at least one door or flap is provided on the energy generating unit via which the drive unit or parts of the drive unit can be removed.

5. An energy generating unit as claimed in claim 1, wherein at least one anchor is provided for anchoring the components at least partially to the bed of the stream.

6. An energy generating unit as claimed in claim 5, wherein the at least one anchor comprises an extractable or releasable suspension device.

7. An energy generating unit as claimed in claim 5, wherein the at least one anchor comprises a self-positioning or self-locking suspension device or connector.

8. An energy generating unit as claimed in claim 1, wherein buoyancy tanks are provided attached to at least some of the components.

9. An energy generating unit as claimed in claim 8, wherein the buoyancy tanks are selectively fillable with varying amounts of water or compressed air.

10. An energy generating unit as claimed in claim 1, wherein at least the draft tube is contructed with buoyancy tanks so as to be independently floatable.

11. An energy generating unit as claimed in claim 1, wherein the draft tube is independently anchored to the bed of the stream.

12. An energy generating unit as claimed in claim 1, further comprising a trapping device arranged in front of the inlet housing.

13. An energy generating unit as claimed in claim 1, wherein the draft tube is constructed as an oval or elliptical diffuser.

14. An energy generating unit as claimed in claim 1, further comprising pick-up points or attachments on the components for lifting the respective components out of the water.

15. A method of maintaining an energy generating unit comprised of a plurality of components disposed on a bed of a stream of water or floating in the water, said method comprising:
separating a component to be maintained from at least one other component while in the water;
removing the separated component from the water for maintenance while the at least one other component remains in the water, and
then reassembling the maintained component to the at least one other component in the water.

16. A method as claimed in claim 15, wherein said energy generating unit comprises an inlet housing, a turbine housing, a drive unit arranged in the turbine housing and a downstream draft tube.

17. A method as claimed in claim 16, wherein the at least one component which remains in the water comprises the draft tube.

18. A method as claimed in claim 16, wherein at least the drive unit is removed from the water for maintenance.

19. A method as claimed in claim 15, wherein the energy generating unit further comprises:
releasable connectors for connecting the components, said connectors being constructed at least partially as remotely operable or releasable latches, and
guides for bringing together adjoining components or moving them apart.
